(19) United States
(12) Patent Application Publication
(10) Pub. No.: US 2006/0055950 A1
(43) Pub. Date: Mar. 16, 2006

(54) Image data registration method, image data registration program, and printing apparatus

(76) Inventors: Toshiyuki Sugimoto, Matsumoto-shi (JP); Junichi Otsuka, Chikuma-shi (JP); Masakazu Honma, Nagano-ken (JP)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/221,110

(22) Filed: Sep. 7, 2005

(30) Foreign Application Priority Data
Sep. 10, 2004 (JP) 2004-263366

(51) Int. Cl. G06K 15/00

(52) U.S. Cl. 358/1.12; 358/1.9

(57) ABSTRACT

Storing image data that is printed at the end of a receipt in a printer is made easier by a printing control apparatus that acquires a distance equal to the length of the transportation path of roll paper between the printing position and paper cutting position of a connected printer, and generates image data by adding non-printing data composed of non-printing dots corresponding to this length to the end of the main print data. This image data is then sent to and stored in the printer.

### RELATED APPLICATIONS

Japanese patent application No. 2004-263366 is hereby incorporated by reference in its entirety.

### BACKGROUND OF THE INVENTION

1. Field of the Invention

The present invention relates to a printing apparatus which can automatically print registered image data on the end of a receipt. The invention further relates to a printing control apparatus that stores image data in a printing apparatus for automatic printing, to an image data registration method, and to an image data registration program.

2. Description of the Related Art

Printing methods for printing image data previously stored in a printer to the beginning, end, or other desired location on a receipt for a sales promotion effect or simply to enhance the appearance of the receipt are known from the literature. The image data thus printed is typically the logo, name, and address of the store, or a coupon, for example. Printers that print pre-registered image data linked to specific text strings found in the print data received from a host computer are also known. Such printers enable adding and printing a logo or other image data on a receipt without modifying the application program running on the host computer. See, for example, JP-A-2004-58323.

However, when image data is automatically printed on the end of a receipt as described above by a printer in which the printing position (the location of the print head) is separated from the paper cutting position (the location of the paper cutter) of the printer, and the printing application causes the printer to cut the paper without feeding the paper after printing is completed, the image data printed at the end of a receipt gets cut off as shown in FIG. 9. To avoid this problem, white space (non-printing) data of a length equal to the paper feed distance between the printing position and the paper cutting position must be added to the image data that is automatically printed on the end of a receipt. Furthermore, because the distance between the printing position and the paper cutting position differs according to the printer model, the non-printing data added to the image data also depends upon the printer model. This imposes an additional burden on the user.

To solve this problem, a printing control apparatus, an image data registration method, and an image data registration program according to the present invention make it easy to add non-printing data to image data that is automatically printed to the end of a receipt and register this data in a printer. A printing apparatus according to the present invention also does not require the user to add the non-printing data to the image data.

### SUMMARY OF THE INVENTION

A printing control apparatus according to a first aspect of the present invention is connected to a printing apparatus that can cut continuous paper after adding and printing previously stored image data on the continuous paper at the end of received print data. The printing control apparatus has a main data acquisition unit for acquiring main data, which is a part of the image data; a non-printing data adding unit for adding to the end of the main data non-printing data of a length corresponding to the distance between a printing position and paper cutting position of the printing apparatus along the transportation path of the continuous paper; and an image data transmission unit for sending the main data and appended non-printing data as the image data to the printing apparatus.

Another aspect of the invention is an image data registration method for registering image data in a printing apparatus that can cut continuous paper after adding and printing previously stored image data on the continuous paper at the end of received print data. This image data registration method has a main data acquisition step of acquiring main data, which is a part of the image data; a non-printing data adding step of adding to the end of the main data non-printing data of a length corresponding to the distance between a printing position and paper cutting position of the printing apparatus along the transportation path of the continuous paper; and an image data transmission step of sending the main data and appended non-printing data as the image data to the printing apparatus.

When the printing apparatus prints image data registered by this printing control apparatus and image data registration method on the end of a receipt, non-printing white space of a length corresponding to the head-to-cutter distance of the printing apparatus is added to the image data. As a result, when the printing position and paper cutting position of the printer are separated, and the printer cuts the roll paper without advancing the paper after printing ends, the main data printed at the end of the print data on the roll paper should not be cut off.

Furthermore, because white space is added automatically according to the head-to-cutter length of the connected printer, the main data portion of the image data can be used with multiple printer models, the user does not need to generate white space data for each different printer model when storing the image data on multiple printer models, and the image data can thus be easily stored on each printer.

This printing control apparatus preferably also has a non-printing data length display unit for displaying the length of the non-printing data. Further preferably, the printing control apparatus also has a non-printing data length setting unit for setting the length of the non-printing data. In this case, the non-printing data adding unit adds non-printing data of the length set by the non-printing data length setting unit instead of non-printing data of a length corresponding to the head-to-cutter distance.

Thus comprised, the user can desirably adjust the length of the non-printing white space data added to the main data while referring to the displayed length of the non-printing data, which is equal to the head-to-cutter distance of the printer. Furthermore, if adding non-printing data is not necessary because of the specifications of the printer or because image data having white space already added thereto is used, adding non-printing data can be effectively disabled by setting the length of the added non-printing data to zero.

Yet further preferably, the printing control apparatus also has a preview display unit for displaying a preview of the image data.

This aspect of the invention can thus display a preview of the registered print data, thereby enabling the user to visually confirm the registered print data and visually verify an image of the added non-printing data instead of simply recognizing the length of the non-printing data as a numeric value.

Yet further preferably, the printing control apparatus also has an editing unit for editing the main data. This arrangement enables the user to set the print size of the image data and the print quality (such as monochrome or color printing, the dither pattern, and tone).

Another aspect of the present invention is a medium embodying a program of instructions executable by the machine, such a computer, to perform the image data registration method as described above.

Yet another aspect of the present invention is a printing apparatus which can add and print previously stored image data on the end of received print data on continuous paper. This printing apparatus has a main data storage unit for storing main data, which is a part of the image data; and a print unit for adding to the end of the main data non-printing data of a length corresponding to the distance between the printing position and paper cutting position along the transportation path of the continuous paper, and adding and printing the main data and non-printing data as the image data to the end of the print data when triggered by a paper cut command.

A printing apparatus according to this aspect of the invention prints image data including main data stored by the printer and non-printing white space data of a length corresponding to the head-to-cutter distance of the printer. As a result, the paper should not be cut with the printed main data cut off even if the user does not add white space.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a POS system according to a preferred embodiment of the present invention;

FIG. 2 is a control block diagram of a printing control apparatus and printing apparatus according to the present invention;

FIG. 3 is a flow chart of a bottom logo printing process of the printing apparatus;

FIG. 4 illustrates an example of the receipt enhancement process;

FIG. 5 shows a registration screen for registering print data with FIG. 5A showing the main data and FIG. 5B showing non-printing data added to the main data;

FIG. 6 is a plan view of the registered print data with FIG. 6A showing the main data and FIG. 6B showing the registered print data after non-printing data is added to the main data;

FIG. 7 illustrates a bottom logo printed to a receipt;

FIG. 8 shows another example of registered print data; and

FIG. 9 illustrates the prior art.

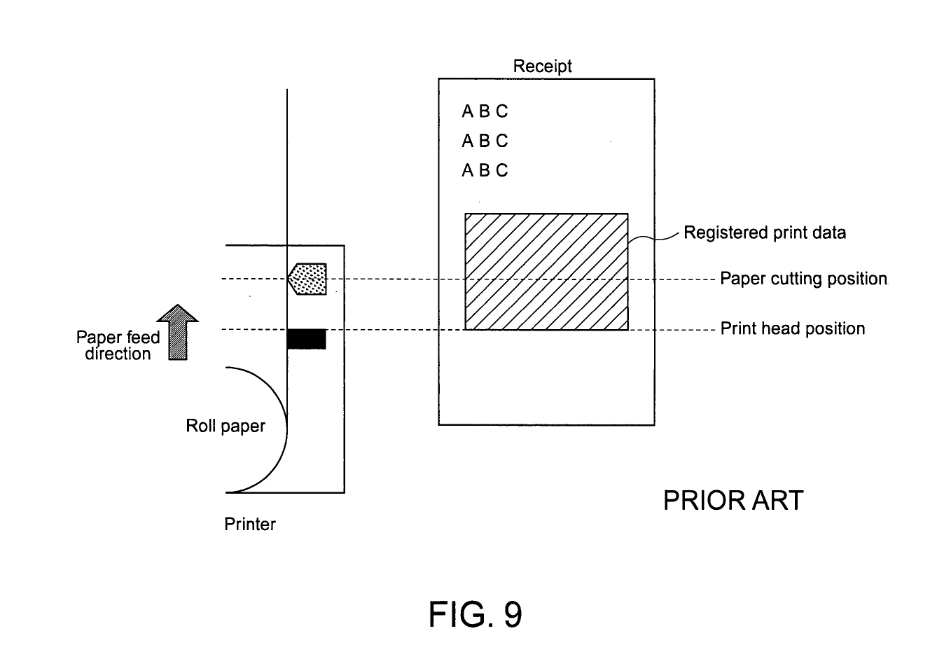

### DESCRIPTION OF THE PREFERRED EMBODIMENTS

Preferred embodiments of the present invention are described below with reference to the accompanying figures.

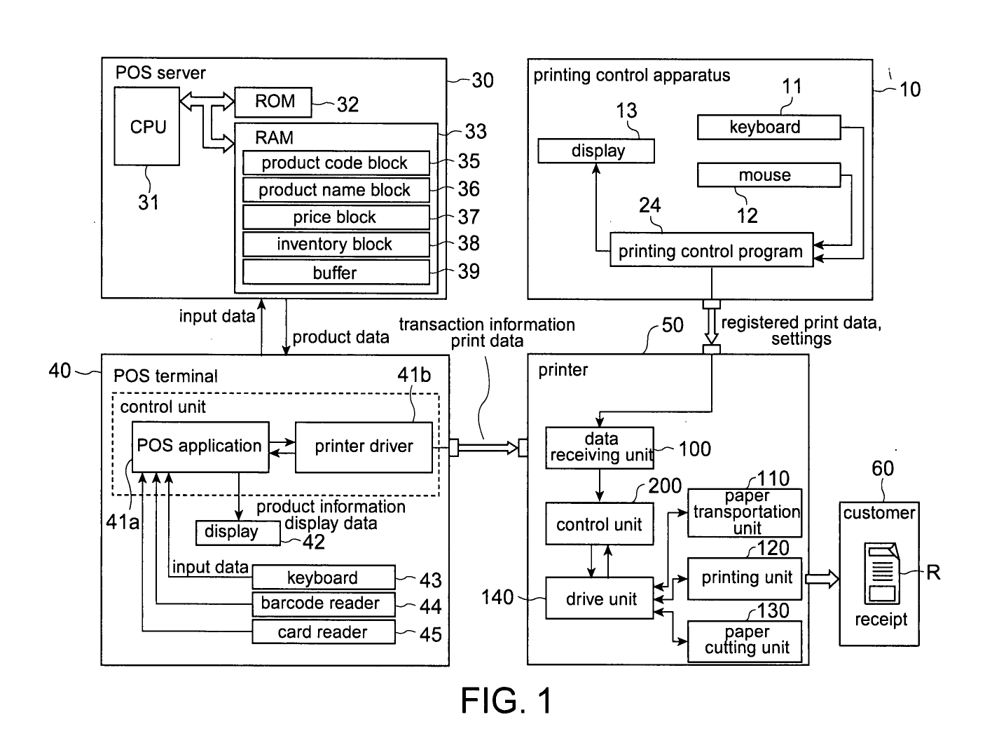

FIG. 1 shows a POS system according to an embodiment of the invention. POS (point of sale) systems are used in supermarkets, convenience stores, and other retail businesses, and print receipts based on input data relating to product sales and data entered by an operator. As shown in FIG. 1, this POS system includes a printer 50, POS terminal 40, POS server 30, and printing control apparatus 10.

The printer 50 prints transaction information print data on roll paper or other recording medium, and issues the printout as a receipt R. The transaction information print data is generated by the POS terminal 40 running a POS application 41a. Based on pre-stored settings, the printer 50 can run a receipt enhancement process described further below to add image data to the transaction information print data received from the POS terminal 40 for printing. The settings relating to this receipt enhancement process are set using a printing control apparatus 10 (utilizing the printing control program 24 described below) connected to the printer 50.

The POS terminal 40 is connected to the printer 50 through a wired or wireless interface, and acquires input data relating to the products as a result of data entry from the keyboard 43 or reading barcodes with a barcode reader 44. A card reader 45 can also be used to read a customer's 60 credit card or membership (preferred customer) card and thereby acquire information needed for credit card transactions or a customer number, for example. The POS terminal 40 also has a display 42 for presenting product information display data generated from product data sent from the POS server 30, and displaying the prices of purchased products for the customer 60. These operations are controlled by the POS application 41a run by the POS terminal 40. The POS application 41a also generates the transaction information print data for printing a receipt R based on the input data and product data, and sends the print data to the printer 50 through the printer driver 41b.

The POS server 30 has a control device (CPU) 31 and memory such as ROM 32 and RAM 33, and processes information stored in the RAM 33 buffer 39 according to a control program stored in ROM 32. More specifically, the POS server 30 stores a product master composed of a product code block 35, product name block 36, price block 37, and inventory block 38 in RAM 33. Based on the input data sent from the POS terminal 40, the CPU 31 extracts the product code, name, and price information from the product master, and generates product data for receipt printing and display on the display 42 of the POS terminal 40.

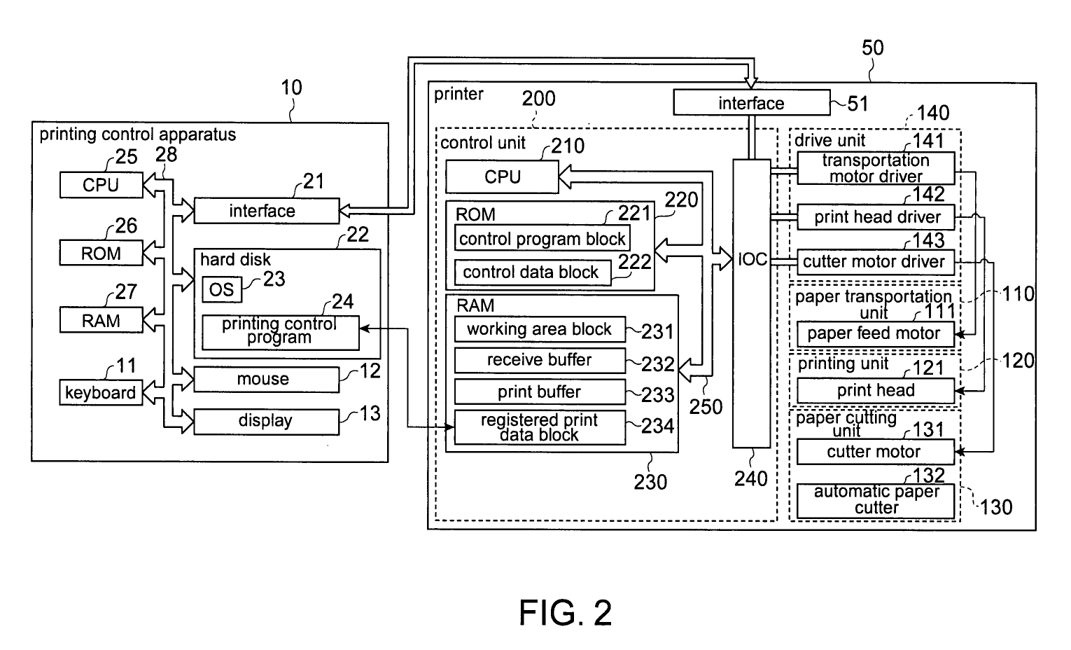

The printer 50 is a receipt printer. In addition to a data receiving unit 100 for receiving control commands and print data from the POS terminal 40 and printing control apparatus 10, the printer 50 has a paper transportation unit 110, printing unit 120, paper cutting unit 130, a drive unit 140 for driving the printing unit 120 and paper cutting unit 130, and a control unit 200 for controlling overall operation of the printer 50. The control unit 200 has memory (RAM 230 as shown in FIG. 2) for storing image data to be added to and printed on a receipt R, and settings related to the image data. Based on these settings, the control unit 200 controls the receipt enhancement process for printing the image data on a receipt R.

The printing control apparatus 10 is a personal computer, for example, and runs a printing control program 24 for editing the image data added to and printed on a receipt R, registering the image data in the printer 50, and setting and retrieving the receipt enhancement process parameters. Using this printing control program 24, display 13, and input devices such as a mouse 12 and keyboard 11, the user can set parameters relating to the receipt enhancement process of the printer 50, and edit, store, or delete the image data.

The printing control apparatus 10 and printer 50 are also connected through a wired or wireless interface. The printing control apparatus 10 is connected to the printer 50 for use when editing and registering the image data, and when setting or retrieving the receipt enhancement process parameters, but is not always connected to the printer 50.

The control arrangement of the printing control apparatus 10 and printer 50 is described next with reference to FIG. 2. In addition to an interface 21 for communicating data with the printer 50, the printing control apparatus 10 has a CPU 25, ROM 26, RAM 27, keyboard 11, mouse 12, display 13, and hard disk 22 interconnected via a system bus 28.

The hard disk 22 stores the OS (Operating System) 23, a printing control program 24 for configuring the printer 50, and other application programs. The hard disk 22 also stores configuration files relating to the startup display and configuration parameters relating to the printing control program 24 and other application programs. The OS 23 is the basic operating system controlling basic printing control apparatus 10 operations, including data input from the mouse 12 and keyboard 11, data output to the display 13, and processes common to programs running under the OS 23.

The CPU 25 controls the printing control apparatus 10 by running operating processes based on the OS 23, printing control program 24, and other applications. ROM 26 stores the BIOS, a program controlling devices such as the keyboard 11, display 13, and hard disk 22, and the OS 23 controls these devices by passing commands to the BIOS. RAM 27 is used by the CPU 25 as a working memory to run the OS 23 and applications read from the hard disk 22 or other storage medium, such as a Compact Disc.

The printer 50 has a data receiving unit 100 (FIG. 1 only) which has an interface 51 and communicates data with the POS terminal 40 and printing control apparatus 10, a paper transportation unit 110 which has a paper feed motor 111 and conveys the recording medium (paper), and a printing unit 120 which has a print head 121 and prints the print data on the paper synchronized to transportation of the paper.

The printer 50 also has a paper cutting unit 130, a drive unit 140, and a control unit 200. The paper cutting unit 130 has an automatic paper cutter 132 and a cutter motor 131 for driving the automatic paper cutter 132, and cuts the trailing end of the paper after printing is completed. The drive unit 140 has a transportation motor driver 141, print head driver 142, and cutter motor driver 143, and thus drives the paper transportation unit 110, printing unit 120, and paper cutting unit 130. The control unit 200 is connected to the drivers 141, 142, 143 of the drive unit 140, and thus controls overall operation of the printer 50.

The control unit 200 has a CPU 210, ROM 220, RAM 230, and input/output controller (10C) 240 connected via a system bus 250. ROM 220 includes a control program block 221 and a control data block 222. The control program block 221 stores the control program run by the CPU 210 to control printing and the receipt enhancement process. The control data block 222 stores control data and tables used to run printing processes, including the receipt enhancement process, based on received control commands and print data.

RAM 230 includes a working area block 231 (which is used for flags, for example), a receive buffer 232 for temporarily storing control commands and print data received by the data receiving unit 100, a print buffer 233 for storing the print data converted to bit-mapped data that can be printed by the printing unit 120, and a registered print data block 234 for storing image data for a plurality of (one or more) images (referred to below as the registered print data) to be printed at a desired location on a receipt R. The image data stored in the registered print data block 234 includes a top logo TL for printing at the top (beginning) of a receipt R, a bottom logo BL for printing at the bottom (end) of a receipt, a keyword logo KL to be added to the receipt R when a specific text string is detected in the print data, and a watermark WM.

In addition to the image data (TL, BL, KL, WM), the registered print data block 234 also stores parameters relating to the image data. These parameters include printing position information (left-aligned, centered, right-aligned). Based on the received control commands and print data and these parameters, the CPU 210 converts the print data and image data to bit-mapped data stored in the print buffer 233. RAM 230 is regularly backed up in order to retain the stored data in the event of a power failure. The registered print data block 234 could alternately be stored in nonvolatile memory.

Logic circuits for complementing the functions of the CPU 210 and handling interface signals to peripheral circuits are composed of gate arrays and custom IC devices and integrated in the IOC 240. The IOC 240 can thus pass control commands and print data received from the POS terminal 40 and printing control apparatus 10 directly, or after processing, to the system bus 250, and in conjunction with the CPU 210 can either directly pass, or process and then pass, data and control signals output from the CPU 210 to the system bus 250 to the printing unit 120 and other units.

The CPU 210 thus runs a control program from ROM 220 and inputs signals and data from the components of the printer 50 through the IOC 240. Based on the input signals and data, the CPU 210 processes data in RAM 230 and outputs signals and data through the IOC 240 to the components of the printer 50, thus controlling the printing process.

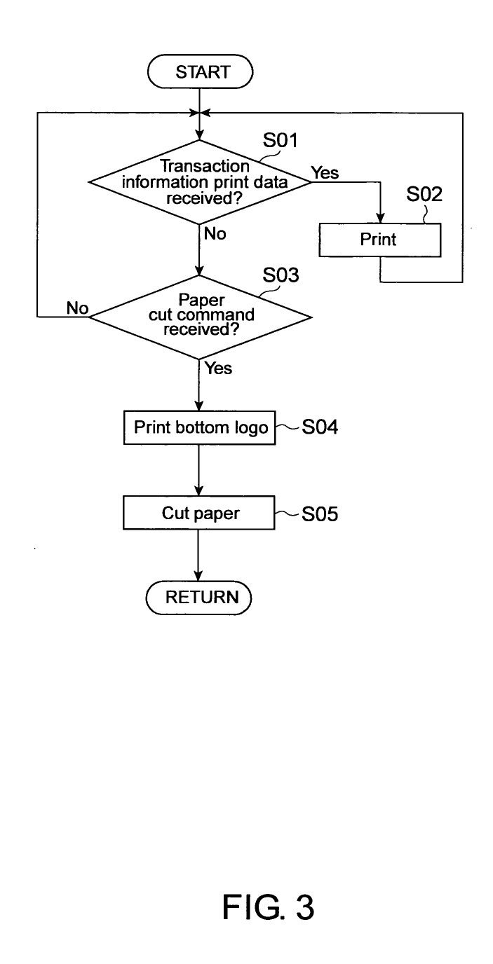

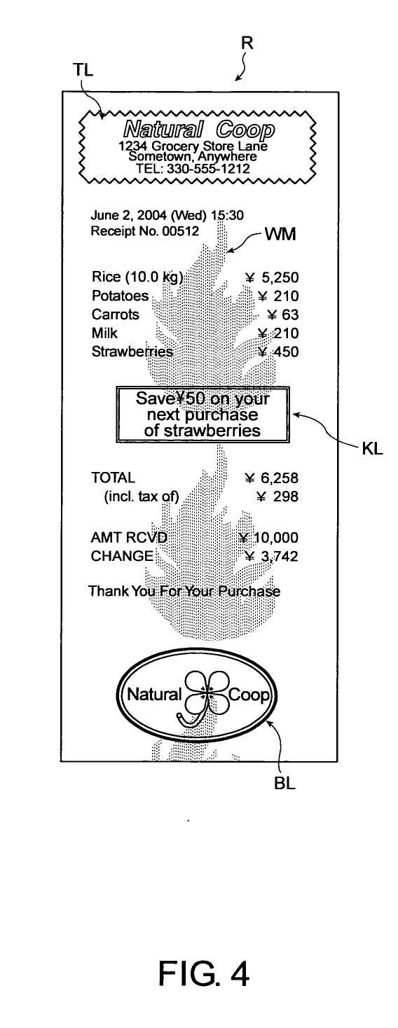

The receipt enhancement process, and more particularly a process for adding a bottom logo BL to transaction information print data received from the POS terminal 40 for printing a receipt R, is described below with reference to FIG. 3 and FIG. 4. The bottom logo BL is dot matrix image data for printing a store logo or coupon, for example, at the end of a receipt as a way of providing store advertising or improving customer service.

As shown in the flow chart in FIG. 3, when the printer 50 receives transaction information print data from the POS terminal 40 (S01 returns yes), the received print data is stored in the receive buffer 232, converted to bit-mapped data in the print buffer 233, and printed by the print head 121 (S02). When a paper cut command is received from the POS terminal 40 (S03 returns yes), the bottom logo BL is printed based on the bottom logo BL image data and bottom logo BL print settings stored in the registered print data block 234 (S04). When printing the bottom logo BL is completed, the paper is cut and a receipt R is issued (S05). This completes the receipt R printing process.

An example of the printed receipt R is shown in FIG. 4. As will be seen from FIG. 4, the receipt enhancement process enables the printer 50 to print a bottom logo BL, a top logo TL, a watermark WM, and a keyword logo KL on the receipt R according to the settings stored in the registered print data block 234.

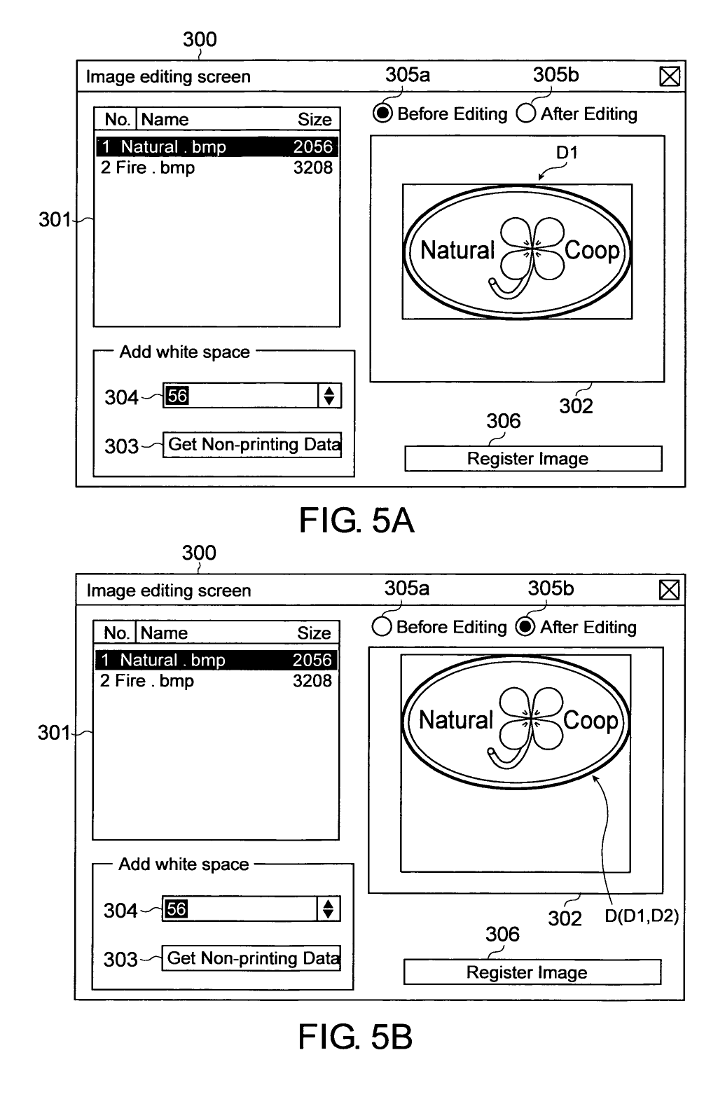

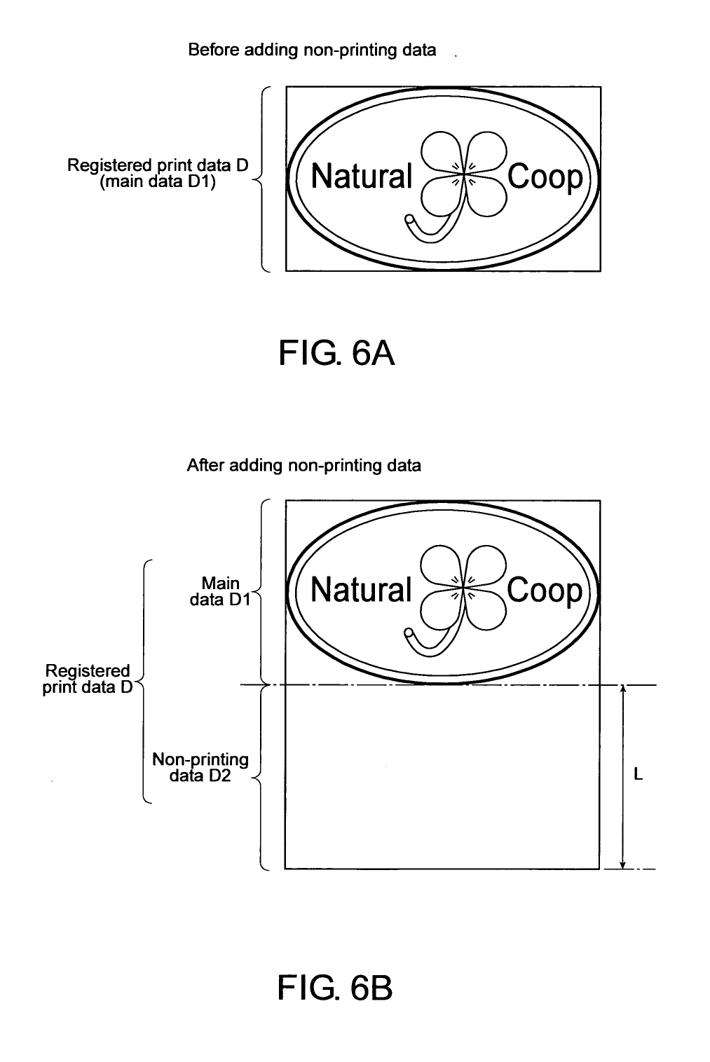

Registering the image data (registered print data) used in the receipt enhancement process is described next with reference to FIG. 5A, FIG. 5B, FIG. 6A and FIG. 6B. This process is controlled by the printing control program 24 of the printing control apparatus 10.

FIG. 5A and FIG. 5B show an image editing screen 300 for registering the registered print data D used in the receipt enhancement process in the printer 50. As shown in the figure, an image list 301 is provided at the top left part of the image editing screen 300. The image list 301 displays the file names of the main data D1, that is, the primary image data in the registered print data D. The main data D1 could be stored inside the printing control apparatus 10, or on an external storage device or network server that can be accessed by the printing control apparatus 10. The user selects the desired main data D1 to be registered from the file names shown in the image list 301. In this example the file “Natural.bmp” is selected. Once the user selects the desired main data D1, a preview of the selected main data D1 is displayed in the preview area 302 located in the upper right part of the image editing screen 300 as shown in FIG. 5A and FIG. 6A. This main data D1 could be an image created by the user using a desired drawing program.

The printing control apparatus 10 according to this embodiment of the invention acquires the head-to-cutter distance L, adds non-printing data (dummy data) composed of non-printing dots of a length equal to distance L to the main data D1, and stores the resulting combination as the registered print data D in the printer 50. The head-to-cutter distance L is the paper feed distance (that is, the distance along the paper transportation path) from the print head (printing position) to the paper cutting position (location of the paper cutter) in the printer 50.

A button 303 for getting the non-printing data is provided at the bottom left part of the image editing screen 300 shown in FIG. 5A and FIG. 5B. When the user clicks on this Get Non-printing Data 303 button, the printing control apparatus 10 starts a process for acquiring the head-to-cutter distance L of the connected printer 50.

A process for acquiring this head-to-cutter distance L is described next.

The printing control program 24 is composed of a main program for registering the registered print date D and setting the parameters related to registering the registered print data D and the receipt enhancement process, and a subprogram for receiving parameters (the printer name, for example) from the main program and providing necessary information to the main program. The main program passes the device name of the printer for which the head-to-cutter distance L is to be acquired (that is, the device name of the connected printer 50) to the subprogram. The device name of the connected printer 50 can be acquired directly from the printer 50 or the user could select the name from a combo box which is not shown. The subprogram then acquires the head-to-cutter distance L from previously stored information (a table containing printer device names and head-to-cutter distance L information) based on the received printer device name, and returns distance L to the main program.

The main program then displays the head-to-cutter distance L received from the subprogram as the length (56 dots in this example) of the non-printing data D2 in a combo box 304 shown at the bottom left of the image editing screen 300. By thus dividing the printing control program 24 into a main program and a subprogram, the printing control program 24 can be updated for compatibility with new printer models by updating only the data table in the subprogram, thus improving printing control program 24 maintenance and utility.

Note that dots are used as the unit of length for the non-printing data D2 in this embodiment, but the invention shall not be so limited and another unit, such as inches, millimeters, or lines, could be used instead.

When the After Editing 305b button above the preview area 302 is pressed, the printing control apparatus 10 displays a preview of the registered print data D, that is, the main data D1 with the non-printing data D2 of the length shown in the combo box 304 appended to the main data D1 as shown in FIG. 5B and FIG. 6B. The user can thus visually verify the length of the actual non-printing data D2 rather than as just a number corresponding to the head-to-cutter distance L of the printer 50.

The user can also edit the value displayed in the combo box 304 to directly specify the length of the non-printing data D2 added to the main data D1. The user can increase the value shown in the combo box 304 to add a space greater than the head-to-cutter distance L of the printer 50 to the main data D1, for example, or set the displayed value to 0 so that no space is added to the main data D1.

Clicking the Before Editing 305a button shown above the preview area 302 switches the preview to show only the main data D1 without the non-printing data D2.

The registration process for registering the registered print data D as a bottom logo BL in the printer 50 is started by clicking the Register Image 306 button at the bottom right part of the image editing screen 300. When this Register Image 306 button is clicked the printing control apparatus 10 sends the registered print data D having non-printing data D2 of the length shown in the combo box 304 added to the main data D1 to the printer 50. The printer 50 then stores the received registered print data D as a bottom logo BL in the registered print data block 234. Though not shown in the figures, the bottom logo BL parameters sent to the printer 50 with the registered print data D include the printing position across the width of the receipt (that is, whether to align the image with the left, the center, or the right).

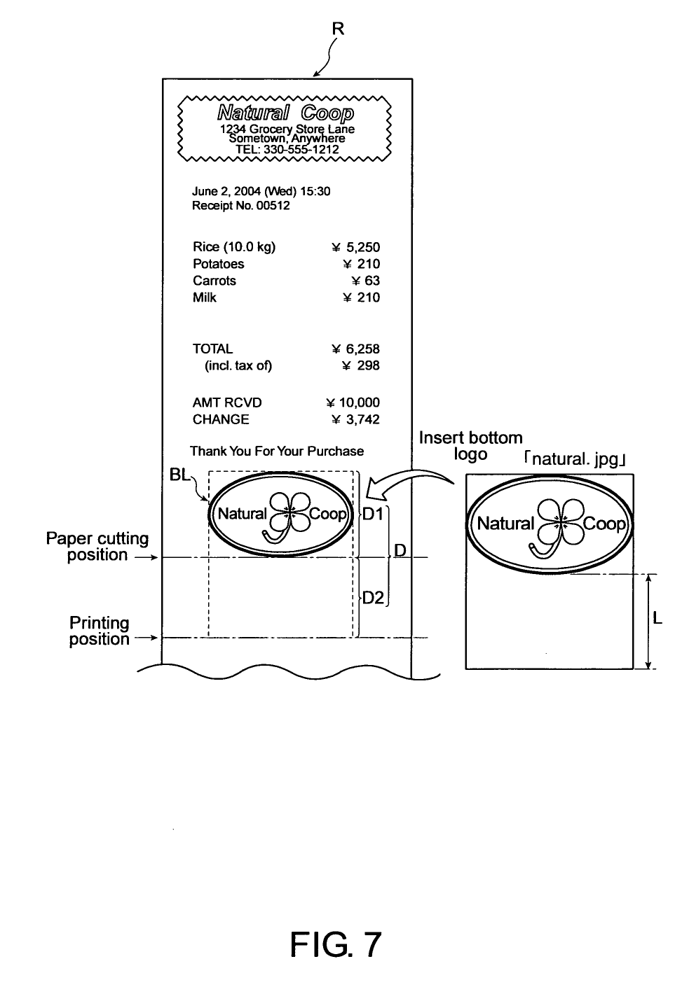

When registered print data D thus having non-printing data D2 added to the main data D1 is printed as a bottom logo BL to the end of a receipt, the main data D1 portion of the printed bottom logo BL will not be cut off even if the paper is cut without feeding the paper after printing the bottom logo BL in a printer 50 in which the printing position and the paper cutting position are separated as shown in FIG. 7.

Furthermore, because non-printing data D2 corresponding to the head-to-cutter distance L of the printer 50 is acquired and added to the main data D1, the main data D1 of the registered print data D can be shared between multiple printer models when the registered print data D is written to multiple printer 50 models, the user does not need to generate non-printing data D2 for each printer model, and the registered print data D can thus be easily stored in each printer 50.

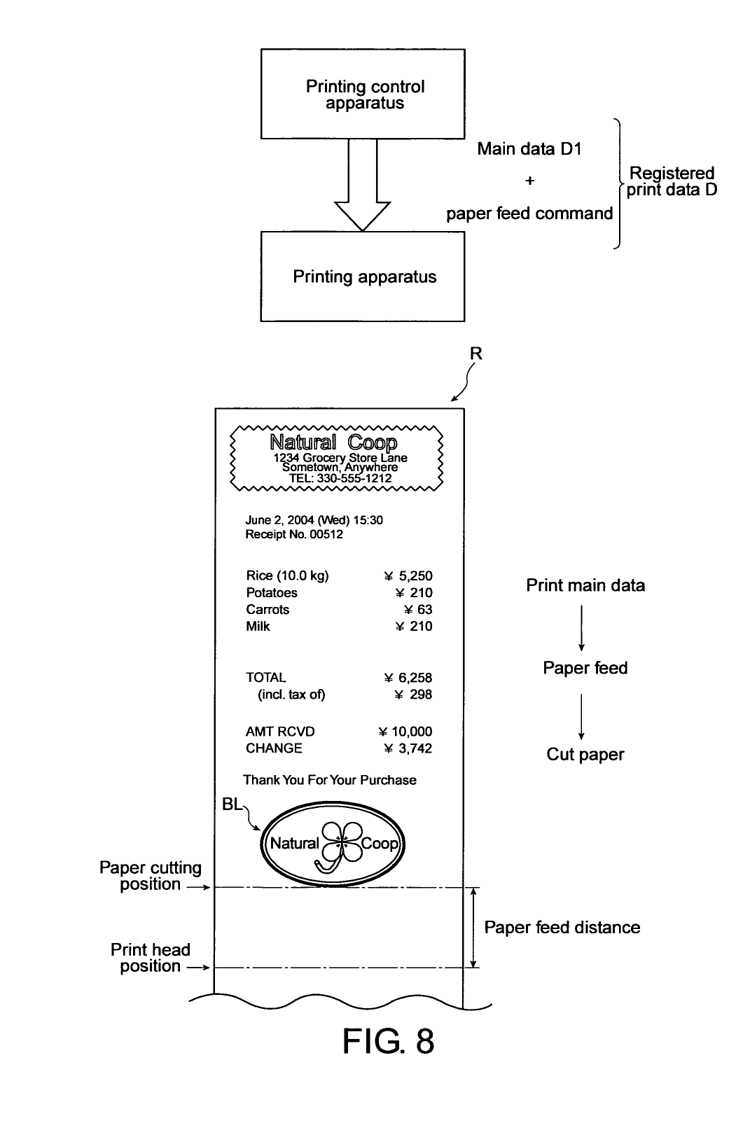

Alternatively, a paper feed command could be added as shown in FIG. 8 instead of adding non-printing data D2. In this case the printing control apparatus 10 acquires the length corresponding to the head-to-cutter distance L of the printer 50, adds a paper feed command for advancing the paper a distance equal to this length to the main data D1, and sends the result as the registered print data D to the printer 50. After the printer 50 then receives a paper cut command, the printer 50 prints the main data D1 stored in the registered print data block 234 as the bottom logo BL, advances the paper according to the paper feed command, and then cuts the paper.

Further alternatively the printer 50 could implement the foregoing control. For example, the printer 50 stores the main data D1 of the registered print data D, prints the main data D1 as the bottom logo BL triggered by receiving a paper cut command, then advances the paper according to the head-to-cutter distance L of the printer, and finally cuts the paper. In this case the paper feed operation corresponding to the head-to-cutter distance L could depend upon printing the non-printing data.

In this embodiment of the invention the POS terminal 40 that runs a POS application 41a for generating transaction information print data and the printing control apparatus 10 that runs the printing control program 24 are separate devices, but these could be combined into one device. This arrangement enables the normal receipt issuing process and the setup process for the receipt enhancement process to run on a single device, thereby simplifying the system configuration and facilitating switching between the receipt issuing process and the setup process for the receipt enhancement process.

Acquiring the head-to-cutter distance L of the printer 50 is also not dependent upon using the Get Non-printing Data 303 button, and the printing control program 24 could automatically acquire this distance L when the program starts up. The value of the distance L could also always be displayed outside of the combo box 304, such as below the combo box 304, rather than in the combo box 304. This allows the user to refer to the head-to-cutter distance L when setting the desired non-printing data D2 in the combo box 304.

Yet further, enabling and disabling the receipt enhancement process could be controlled by a control command or switch. Alternatively, the receipt enhancement process could be automatically enabled if registered print data is stored in the registered print data block 234, and disabled if the registered print data is not stored.

The printing control program 24 could also have a function for specifying the print size of the registered print data D (or main data D1), and a function for specifying the print quality (monochrome/color, dither pattern, and tone, for example).

The parts (function of the parts) of the printing control apparatus 10 and printer 50 described above can also be embodied as a computer-executable program. This program can also be stored on a data storage medium executable by a machine, such as a computer. Examples of such media include flash ROM, memory cards (including Compact Flash (R), SD memory cards, and memory sticks), Compact Disc (R), magneto-optical disc, DVD media, and floppy disks.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A printing control apparatus connected to a printing apparatus that can cut continuous paper after adding and printing previously stored image data on the continuous paper at the end of received print data, comprising:
a main data acquisition unit that acquires main data, which is a part of the image data;
a non-printing data adding unit that appends to the end of the main data non-printing data of a length corresponding to a distance between a printing position and paper cutting position of the printing apparatus along a transportation path of the continuous paper; and
an image data transmission unit for sends the main data and appended non-printing data as the image data to the printing apparatus.

2. The printing control apparatus of claim 1, further comprising a non-printing data length display unit that displays the length of the non-printing data.

3. The printing control apparatus of claim 1, further comprising a non-printing data length setting unit that sets the length of the non-printing data;
wherein the non-printing data adding unit adds non-printing data of the length set by the non-printing data length setting unit instead of non-printing data of a length corresponding to the head-to-cutter distance.

4. The printing control apparatus of claim 1, further comprising a preview display unit that displays a preview of the image data.

5. The printing control apparatus of claim 1, further comprising an editing unit that edits the main data.

6. An image data registration method for registering image data in a printing apparatus that can cut continuous paper after adding and printing previously stored image data on the continuous paper at the end of received print data, the method comprising:
acquiring main data, which is a part of the image data;
appending to the end of the main data non-printing data of a length corresponding to a distance between a printing position and paper cutting position of the printing apparatus along a transportation path of the continuous paper; and
sending the main data and appended non-printing data as the image data to the printing apparatus.

7. The image data registration method of claim 6, further comprising displaying the length of the non-printing data.

8. The image data registration method of claim 6, further comprising setting the length of the non-printing data;
wherein the step of appending non-printing data adds non-printing data of the length set by step of setting the length of the non-printing data instead of non-printing data of a length corresponding to the head-to-cutter distance.

9. The image data registration method of claim 6, further comprising displaying a preview of the image data.

10. The image data registration method of claim 6, further comprising editing the main data.

11. A medium readable by a machine embodying a program of instructions executable by the machine to perform the method of claim 6.

12. A printing apparatus that can add and print previously stored image data at the end of received print data on continuous paper, comprising:
a main data storage unit that stores main data, which is a part of the image data; and
a print unit that adds to the end of the main data non-printing data of a length corresponding to a distance between a printing position and a paper cutting position along a transportation path of the continuous paper, and adds and prints the main data and non-printing data as the image data to the end of the print data when triggered by a paper cut command.
